(19) United States
(12) Patent Application Publication
(10) Pub. No.: US 2014/0029371 A1
(43) Pub. Date: Jan. 30, 2014

(54) Foam Production System and Method

(71) Applicant: Paul M. Falco, Dana Point, CA (US)

(72) Inventor: Paul M. Falco, Dana Point, CA (US)

(21) Appl. No.: 13/560,882

(22) Filed: Jul. 27, 2012

(51) Int. Cl. B28C 5/06

(52) U.S. Cl. 366/10

(57) ABSTRACT

A foam production system for producing a foam suitable for combining with a concrete mix comprises an air actuator for providing pressurized air to an aerator assembly and a water actuator arranged to provide pressurized water. A foaming agent is added to the water in a mixing chamber. The mixture of water and foaming agent is pumped out of the mixing chamber to the aerator, which is arranged to mix pressurized air into the mixture of a water and foaming agent to produce a foam output that is suitable for being combined with concrete mix to produce foamed concrete.

### BACKGROUND OF THE INVENTION

This invention relates generally to a system for producing a foam suitable for adding to concrete mix.

The present invention relates generally to a foam producing apparatus and method, and is particularly concerned with such an apparatus usable for entraining air bubbles in concrete to produce various types of lightweight concrete structures such as concrete wall panels having a high density of air voids.

It has been known for some time that lighter weight concrete structures can be made by entraining air bubbles in the concrete mixture at some point prior to placing the concrete, so that the concrete hardens to leave air voids throughout the structure. This type of lightweight concrete is generally known in the field as cellular concrete. Cellular or foamed concrete may be made by pre-forming a foam and then adding the foam to a slurry of cement, aggregate and water in a mixing device. Another known technique is to add a gas-forming agent to the slurry, causing the mix to swell as gas bubbles are formed. The reduced density of cellular concrete, and thus the reduced weight, reduces transportation and handling costs, and also reduces the dead load imposed on a structure constructed from such concrete. It also has better heat insulation, freeze and thaw resistance, reduced water permeability and sound absorption properties than conventional concrete.

This invention incorporates an aerator device similar to the aerator described in U.S. Pat. No. 5,900,191, that issued May 4, 1999 to Gray and Masters and that is incorporated by reference into this disclosure.

### SUMMARY OF THE INVENTION

A foam production system according to the present invention for producing a foam suitable for combining with a concrete mix, comprises an air actuator for providing pressurized air; an air pressure regulator arranged to receive pressurized air from the air actuator and provide an air output having a selected air pressure; an aerator assembly arranged to be in fluid communication with the air pressure regulator to receive pressurized air therefrom; and a water actuator arranged to provide pressurized water. The foam production system further comprises a mixing chamber arranged to be in fluid communication with the water actuator to receive water therefrom; a foaming agent tank arranged to be in fluid communication with the mixing chamber to provide a foaming agent that is mixed with water in the mixing chamber; a pump arranged to pump a mixture of water and the foaming agent out of the mixing chamber; and a water pressure regulator arranged to receive the mixture of water and foaming agent output from the pump and to provide the mixture in the aerator at a selected liquid pressure. The aerator assembly is arranged to mix pressurized air into the mixture of water and foaming agent to produce a foam output that is suitable for being combined with concrete mix to produce foamed concrete.

The foam production system according to the present invention preferably further comprises an input air pressure gauge arranged to measure the pressure of air input to the air actuator; an output air pressure gauge arranged to measure the pressure of air output from the air pressure regulator; an input water pressure gauge arranged to measure the water pressure of water input to the mixing chamber; and an output water pressure gauge arranged to measure the pressure of the mixture of water and foaming agent output from the water pressure regulator.

One embodiment of the invention is a version that is suitable for attachment to a cement mixing/transport truck to dispense foam before, during and/or after transport.

### BRIEF DESCRIPTION OF THE DRAWINGS

FIG. 1 is a functional block diagram of a first embodiment of a foam production system according to the present invention;

FIG. 2 is a bottom plan view of an aerator assembly that may be included in a foam production system according to the present invention;

FIG. 3 is a perspective view showing input and output ports of the aerator assembly of FIG. 2;

FIG. 4 is a perspective view of an atomizer that may be included in the aerator assembly of FIGS. 2 and 3;

FIG. 5 is a cross sectional view of the showing atomizers that may be included in the atomizer of FIGS. 2 and 3;

FIG. 6 is a side elevation view of the of the atomizer as shown in FIGS. 5;

FIG. 7 is and end elevation view of the atomizer of FIG. 6;

FIG. 8 is a cross sectional view of the aerator showing the atomizer therein and showing air and liquid inputs to the aerator;

FIG. 9 is a cross sectional view showing liquid flow into the atomizer;

FIG. 10 is a cross sectional view showing a portion of a mixing chamber that may be included in the aerator;

FIG. 11 is a side elevation view showing an agitator that may be placed in the mixing chamber of FIG. 10;

FIG. 12 is a functional block diagram of a second embodiment of a foam production system according to the present invention

FIG. 13 is a perspective view showing a dual aerator assembly that may be included in the embodiment of the invention shown in FIG. 12.

### DETAILED DESCRIPTION OF THE INVENTION

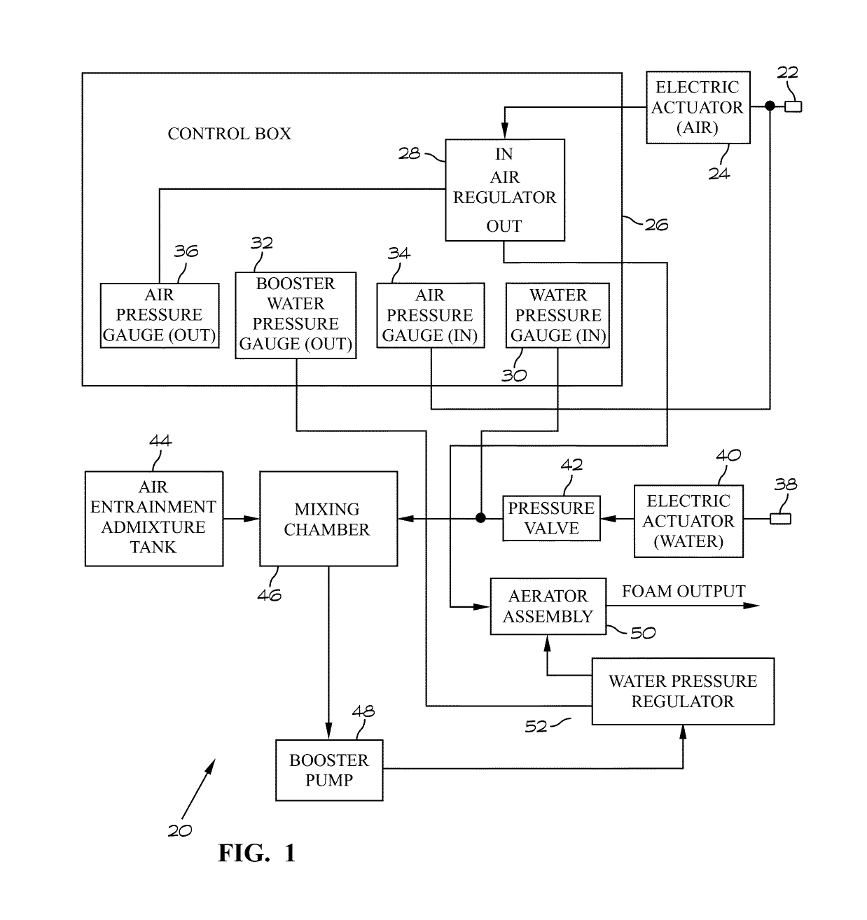

Referring to FIG. 1, a foam production system 20 according to the present invention includes an air intake 22 that inputs air to a first electric actuator 24 and a water intake 38 that inputs water to a second electric actuator 40. The electric actuator 24 provides air to an air regulator 28 that is included in a control box 26. The air regulator provides pressurized air to an aerator assembly 50. A first air pressure gauge 34 in the control box 26 measures the pressure of the air input to the first electric actuator 24, and a second air pressure gauge 36 in the control box measures the pressure of the air that is output from the air regulator 28 to the aerator assembly 50.

The second electric actuator 40 provides water to a pressure valve 42 that in turn inputs the pressurized water into a mixing chamber 46. A first water pressure gauge 34 in the control box measures the pressure of water that the pressure valve 42 provides to the mixing chamber 46. A tank 44 that contains an air entrainment admixture that is provided to the mixing chamber 46 to be mixed with water. A booster pump 48 pumps the water-air entrainment mixture to a pressure regulator 52. A booster water pressure gauge 32 in the control box 26 is connected to the pressure regulator 52 for monitoring the pressure therein. The water-air entrainment mixture is output from the pressure regulator 52 to the aerator assembly 50 to be mixed with pressurized air from the air regulator 28 to form a foam that is then output from the aerator assembly 50.

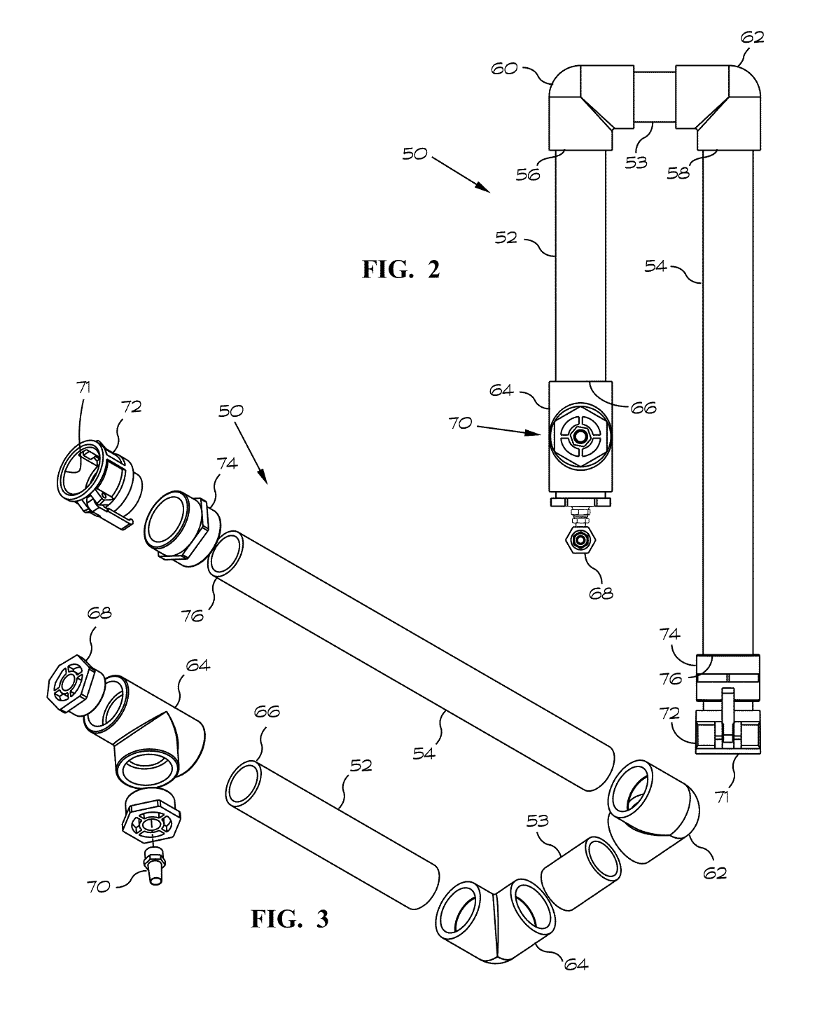

The bottom plan view of FIG. 2 and the perspective view of FIG. 3 show an embodiment of the aerator assembly 50 that is comprised of three straight pipes 52-54. The pipes 52 and 54 are parallel with the pipe 53 connected between the pipes 52 and 54 at their ends 56 and 58 by two 90° pipe elbows 60 and 62. A pipe fitting 64 is connected to an end 66 of the pipe 52. An air inlet 68 is connected to the fitting 68 and is arranged to receive pressurized air from the air pressure regulator 28 of the block diagram of FIG. 1. The fitting 66 also includes a liquid inlet 70 that is arranged to receive a mixture of water and the foaming agent from the water pressure regulator 52 of FIG. 1. The aerator assembly 50 forms air bubbles in the mixture of water and the foaming agent to form a foamed liquid-like composite material that exits the aerator assembly 50 at an outlet 71 formed in an outlet fitting 72. The foamed liquid is suitable for mixing with concrete or other material that is to be foamed.

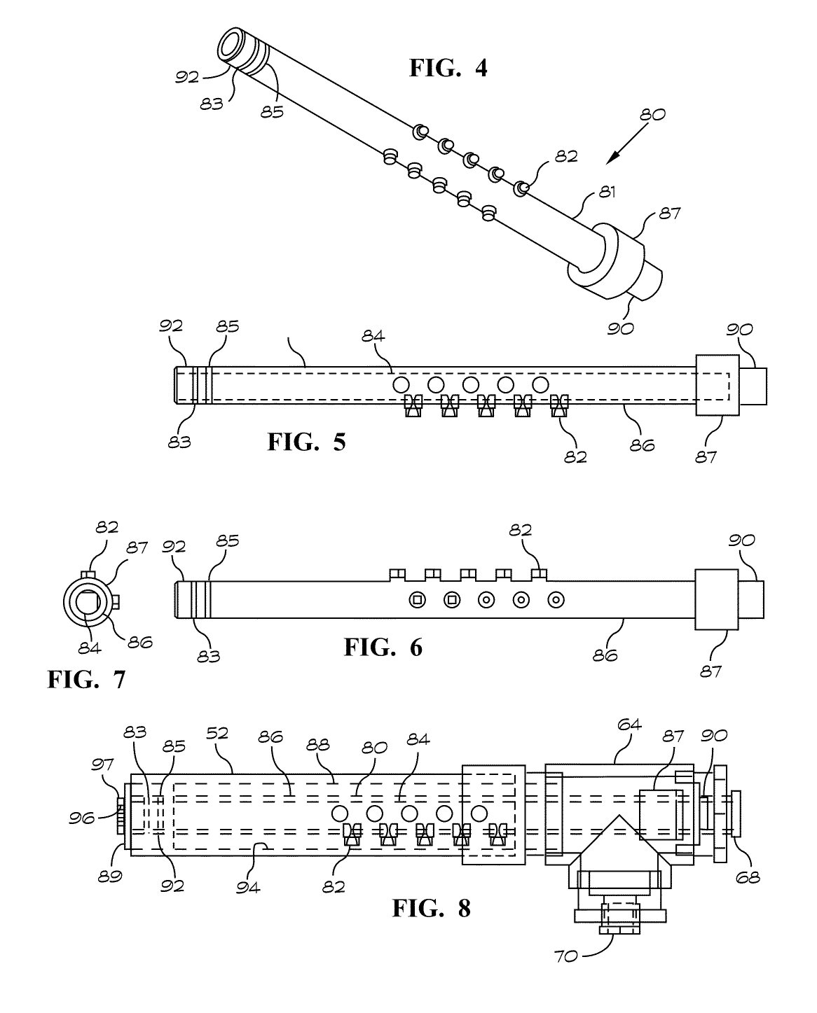

FIGS. 4-8 illustrate an atomizer 80 that may be included in the aerator assembly 50. The atomizer 80 is formed as an elongate pipe or tube 81 having a plurality of ports 82 therein. As best illustrated in FIGS. 5 and 8, the ports 82 preferably are Venturi passages. However, straight-sided orifices or other configurations may be used in other embodiments. The number of ports shown is merely an example of an embodiment of the atomizer 80, which actually could include a greater or lesser number of ports than the number shown in FIGS. 4-8.

Referring to FIGS. 5 and 7, the atomizer 80 is hollow and has an inner wall 84 and an outer wall 86. Referring to FIG. 8, when the aerator assembly 50 is assembled, the atomizer 80 is placed inside the pipe 52 and secured at ends 90 and 92 so that there is a void 94 between the inner wall 88 of the pipe 52 and the outer wall 86 of the atomizer 80. A bushing 87 may be mounted to the atomizer near the end 90 thereof. So that the end 90 is secured inside the fitting 64. A bushing 89 may be mounted inside the pipe 52 so that the O-rings 83 and 85 near the end 92 of the atomizer fits closely against the inner wall of the bushing 89.

The mixture of water and the foaming agent flows into the void 94 via the input port 70. Air is input to the atomizer 80 via the air input port 68. The bushings 87 and 89 and the O-rings 83 and 85 cooperate to seal the void 94 so that the liquid mixture of water and foaming agent cannot flow past the outer wall 86 of the atomizer 80. The pressure of the mixture of water and foaming agent in the void 94 is greater than the air pressure input to the atomizer 80 via the air inlet 68 so that the mixture of water and foaming agent is forced into the inner chamber 95 in the atomizer 80. The bushing 89 seals the end of the void 90 so that the mixture of water and foaming agent cannot flow through the void 90 into the pipe 53.

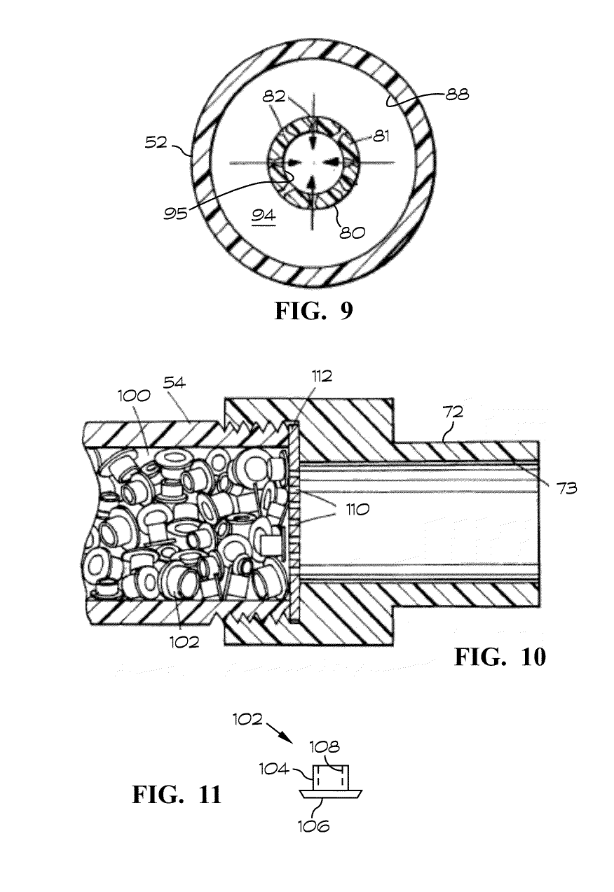

The air may be supplied to air inlet 68 at a pressure in the range from 100 psi±10 psi, while the water/foaming agent mixture may be pressurized to a pressure of 175 psi.±25 psi. By varying the geometry or quantity of the water, jet orifices of the mixing tube or the geometry or medium of the mixing chamber, pressures and pressure relationships may vary significantly. The geometry, orifice size, and pressure relationships must be such that the foam solution is atomized into tiny droplets, to ensure formation of very fine bubbles in the foam. Because of the pressure differential, the aqueous foaming agent will be forced inwardly through the ports 82, and will be atomized into droplets, or a fine spray, due to passage through the ports 82. The arrows in FIG. 9 show the flow of the mixture of air and foaming agent into the inner chamber 95 of the atomizer 80. The atomized droplets are propelled by the pressurized air along the tube 81 and through a plurality of openings 96 in an end plate 97 (FIG. 8) into an agitation chamber 100 that is inside the pipes 53 and 54.

The agitation chamber 100 is filled with a suitable agitating medium that may comprise a plurality of eyelets or tubular members 102 that may be formed in three or more different sizes. The agitation chamber 100 is closed at its outer end by a sealing disc or retainer 110 having a plurality of small passages 112 therethrough as shown in FIG. 10.

FIGS. 10 and 11 illustrate one preferred embodiment of the eyelets 102. As best illustrated in FIG. 11, each eyelet 102 has a sharp-edged tubular section 104 with an annular rim 106 at one end and has a through bore or passage 108. The eyelets 102 may be formed of brass or other materials, and a plurality of different size eyelets may be used to fill chamber 100 if desired.

In the agitation chamber 100 the droplets are forced through the multiple randomly oriented tubular openings 108 in eyelets 102 with severe changes in direction, compression, expansion and violent agitation. This causes a foam to be produced that comprises fine bubbles, each containing water. The density of the foam, i.e. the amount of water in a unit quantity of foam, can be varied by changing the pressures at inlets 68 and 70. This allows the foam density to be varied in the range from 6-11 oz. per gallon of foam, or 45-80 gm of water per liter of foam. Generally, lower inlet pressures produce a foam with a higher density of water, so that an air inlet pressure of 90 psi. and a foamable liquid inlet pressure of 150 psi. produce a foam of around 80 gm. water per liter, while an air inlet pressure of 110 psi. and a foamable liquid inlet pressure of 175 psi. produces a foam of around 45 gm. of water per liter. By varying the geometry, quantity of water, jet orifices of the mixing tube, or the geometry of medium of the mixing chamber, pressures and pressure relationships may vary significantly.

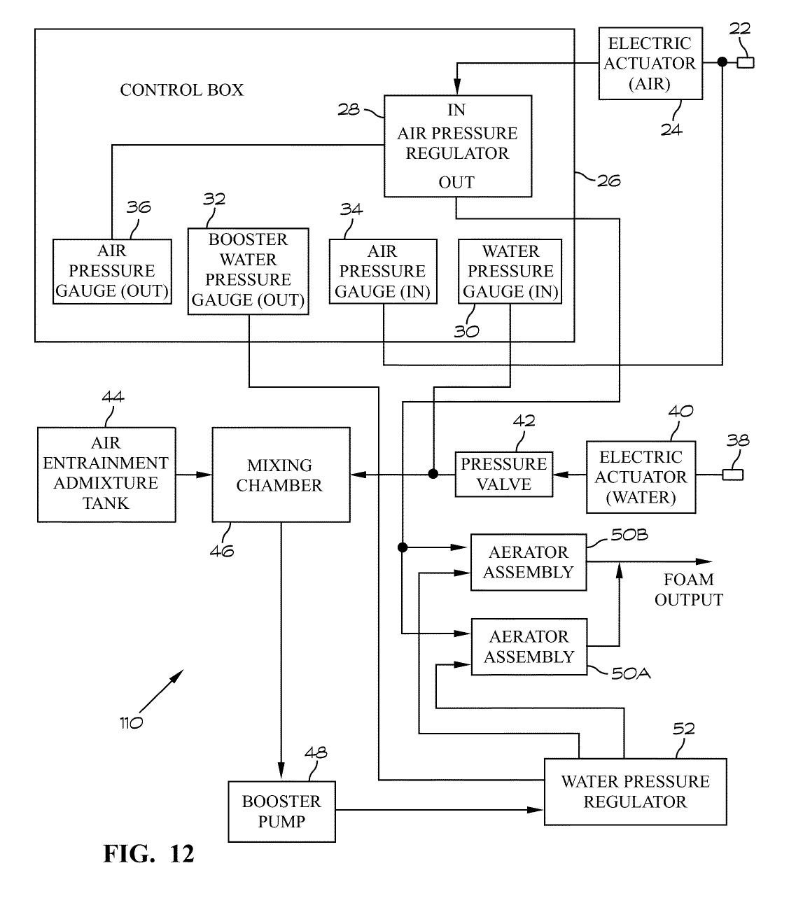

Referring to FIG. 12, a foam production system 110 according to the present invention includes a pair of aerator assemblies 50A and 50B, which preferably are essentially identical. The aerators 50A and 50B each receive air from the air pressure regulator.

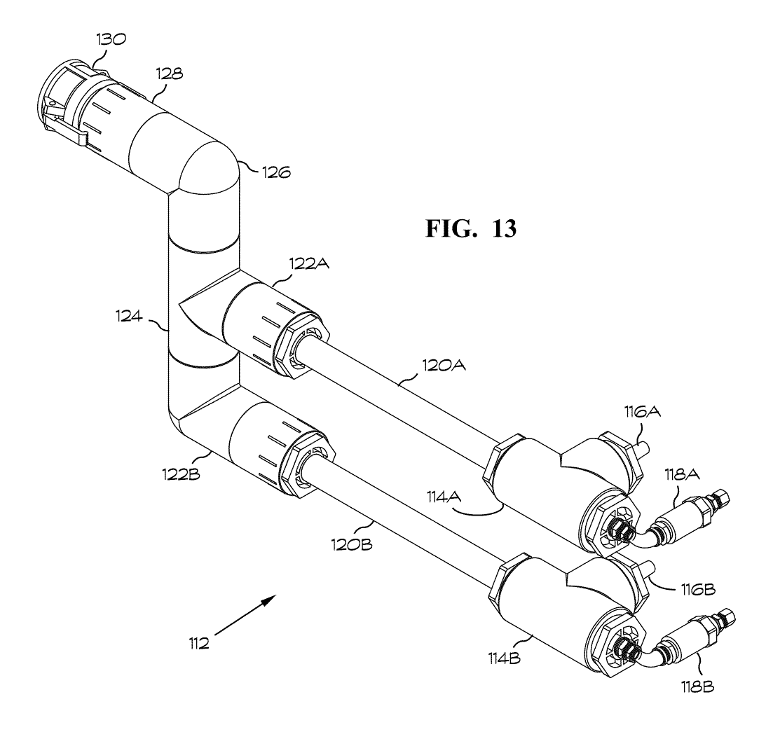

FIG. 13 is a perspective view showing a dual aerator assembly 112 that is suitable for forming the foam production system 110 of FIG. 12. Pipe fittings 114A and 114B receive liquid inputs from liquid inlets 116A and 116B, respectively. The pipe fittings 114a and 114B also receive air inputs from air inlets 118A and 118B, respectively. The air and liquid inputs mix together in atomizers 120A and 120B that are connected to the pipe fittings 114A and 114B, respectively. The atomizers 120 and 120B both are preferably formed in accordance with the atomizer 80 previously described. The present invention is not limited to having one or two aerator assemblies. Any desired number of aerator assemblies may be included in a foam production system according to the present invention.

A fine spray of the foaming agent and air is output from the atomizers 120A and 120B via pipe fitting 122A and 122B, respectively. The atomizer outputs are combined in a pipe fitting 124 and then forced through a pipe elbow 126 into an agitation chamber 128. The agitation chamber 128 preferably is formed to have the structure and functions of the agitator 100 previously described. The foam output of the agitation chamber 128 passes through an outlet 130, which preferably has quick connect/disconnect fittings.

As discussed above, one possible advantageous use for the foam produced by this apparatus is mixing with liquid concrete to produce a foamed concrete material that can be pre-cast in a mold or cast on site, to produce air-entrained, lightweight concrete on drying. Where the foam is to be mixed with concrete, suitable foaming agents for mixing with water to produce the foam in apparatus 10 are and similar surfactants or foaming agents used in the foaming of concrete. The use of such foaming agents with the pressure differentials described above and the apparatus of FIGS. 1-13 has been found to produce a thick; creamy foam of fine bubbles that are extremely resistant to collapse and are long-lasting, even when mixed with concrete for extended intervals of several hours. Since the bubbles are retained within the concrete material for longer periods of time without collapsing, they will still be present when the concrete is cast or placed. As the concrete hardens, the heat of concrete curing will collapse the bubbles, releasing the trapped water that the concrete will use in order to fully hydrate. Thus, there is less need to wet the concrete during curing, as is normally necessary with conventional, unfoamed concrete.

What is claimed is:

1. A foam production system for producing a foam suitable for combining with a concrete mix, comprising:
an air actuator for providing pressurized air;
an air pressure regulator arranged to receive pressurized air from the air actuator and provide an air output having a selected air pressure;
an aerator assembly arranged to be in fluid communication with the air pressure regulator to receive pressurized air therefrom;
a water actuator arranged to provide pressurized water;
a mixing chamber arranged to be in fluid communication with the water actuator to receive water therefrom;
a foaming agent tank arranged to be in fluid communication with the mixing chamber to provide a foaming agent that is mixed with water in the mixing chamber;
a pump arranged to pump a mixture of water and the foaming agent out of the mixing chamber; and
a water pressure regulator arranged to receive the mixture of water and foaming agent output from the pump and to input the mixture to the aerator assembly at a selected liquid pressure, the aerator assembly being arranged to mix pressurized air into the mixture of a water and foaming agent to produce a foam output that is suitable for being combined with concrete mix to produce foamed concrete.

2. The foam production system of claim 1, further comprising:
an input air pressure gauge arranged to measure the pressure of air input to the air actuator;
an output air pressure gauge arranged to measure the pressure of air output from the air pressure regulator;
an input water pressure gauge arranged to measure the water pressure of water input to the mixing chamber; and
an output water pressure gauge arranged to measure the pressure of the mixture of water and foaming agent output from the water pressure regulator.

3. The foam production system of claim 1 wherein the aerator assembly includes a plurality of aerators.
